(19) United States
(12) Patent Application Publication
(10) Pub. No.: US 2014/0317891 A1
(43) Pub. Date: Oct. 30, 2014

(54) Method For The In-Situ Production Of A Fastening Element

(71) Applicant: nolax AG, Sempach Station (CH)

(72) Inventors: Patrick Steiner, Schattdorf (CH); Sebastian Meyer, Sursee (CH); Anton Brandmair, Nottwil (CH); Willi Schwotzer, Neuenkirch (CH)

(21) Appl. No.: 14/356,372

(22) PCT Filed: Oct. 30, 2012
(86) PCT No.: PCT/EP2012/071420

§ 371 Date: May 5, 2014

(30) Foreign Application Priority Data
Nov. 7, 2011 (EP) 11188047.2

(51) Int. Cl. B29C 65/54; B29C 65/70

(52) U.S. Cl. CPC B29C 65/542; B29C 65/70
USPC 24/304; 156/66; 156/578; 264/259; 425/500

(57) ABSTRACT

The invention relates to a method for the in situ production of fixing elements (5) on one or more substrates (4) using an adhesive to be applied in liquid form, said method having the steps of providing the substrate(s) (4), arranging a single-part or multi-part casting mold (1), filling the casting mold (1) with liquid adhesive, and curing the adhesive on the substrate(s) (4). Said method is also used with non-porous and non-transparent substrates (4) in a work step and is suitable for attaching load-bearing fixing elements (15).

### BACKGROUND OF THE INVENTION

The invention concerns a method for the in-situ production of fastening elements with the aid of liquid adhesive on substrates and to the use of an adhesive to be applied in liquid form for the in-situ production of fastening elements on substrates according to the features of the independent claims. These fastening elements serve for the mechanical mounting of elements, for example coverings or panelings.

The form-fitting connection, brought about by the geometry of the parts being connected, or material-bonding connection, held together by molecular forces, of fastening elements, such as for example brackets, angles, retaining bolts or mounting clips, by means of screws, rivets or pins or by adhesive is known from the prior art.

For instances of material-bonding mounting by means of adhesive, a large number of adhesive systems are used. For instance, for fastening elements that are subjected to no or little mechanical loading, pressure-sensitive adhesives or pressure-sensitive adhesive tapes are used, these allowing quick connections but being unsuitable for load-bearing connections because of their creeping characteristics.

Better suited for the mounting of fastening elements that are permanently under mechanical loads and transfer the loads to mounting surfaces are thermosetting systems, i.e. adhesives that crosslink when they are applied and do not fail later as a result of cold flow. Typical two-component systems are based on polyurethanes, epoxides or acrylates. The disadvantage of these systems is the relatively slow curing time, during which the fastening element must be held in position.

Likewise suitable are one-component adhesive systems on the basis of moisture-curing hotmelt adhesives. By virtue of the initial adhesion they undergo as a result of their hotmelt properties, these do not have the disadvantageous characteristics of the two-component systems, but require a reaction with water to perform, and thereby achieve the required properties, which may present a problem when closed surfaces are involved. This also applies to cyan-acrylate systems, which have to be started by water and also usually have a low resistance to water.

EP 1 947 156 B1 describes the connecting of non-transparent parts by an adhesive that cures by irradiation. Thermally latent-reactive systems, the curing of which is initiated by sudden exposure to heat after the positioning of the fastening element, are also known. Here, too, a second process step is required each time. In the case of the adhesive that is curable by irradiation, a transparent element must be insertable between the parts to be connected.

DE 10 2007 010 540 A1 discloses a solution to this problem by means of what are referred to as adhesive rivets. This involves applying a conventional two-component system to the surfaces to be stuck together. For fixing the parts during the curing process, dowel-like connections are created by filling slots that pass through both adhesive surfaces with rapidly curing adhesive systems. Also in the case of this method, two process steps are required.

All thermosetting systems have the disadvantage that they either cure slowly or require a second process step for curing.

U.S. Pat. No. 4,735,753 concerns the in-situ production of a fastening element in the form of a snap-fastener stud and the associated sleeve of plastic, which are produced by liquefying a piece of plastic with the aid of an ultrasonic device, applying it to a porous substrate, such as for example a fabric, and shaping it from above and below with the aid of a die to form the corresponding snap-fastener parts. The plastic thereby penetrates into the pores on the surface of the substrate and leaves again on the underside. This method cannot be used on smooth surfaces.

Consequently, the object of the invention is to overcome the disadvantages of the prior art, i.e. to attach load-bearing fastening elements with the aid of a method that is quick, requires just one working step and can also be applied to non-porous and non-transparent substrates.

### DESCRIPTION OF THE INVENTION

This object is achieved by the subjects of the independent claims.

The method according to the invention is suitable for the in-situ production of fastening elements on one or more substrates with the aid of liquid adhesive and is characterized in that one or more substrates are provided, a one- or multi-part casting mold is arranged on the substrate or the substrates, the casting mold is filled with a liquid adhesive through an opening and the adhesive cures.

Fastening elements may be brackets, angles, bolts, clips, sleeves, internal threads, screws, pins, recesses, projections, rails, barbs or rivets.

Substrates may have differing roughnesses of the surface or a porous surface. A single substrate may also have varyingly rough or porous regions of its surface. The fastening elements of adhesive according to the invention adhere on substrate surfaces of low roughness as well as on porous surfaces or surfaces that are very rough. Moreover, substrates that are non-transparent can be used.

The adhesive is for example a rapidly curing polyurea-based two-component adhesive, as described in EP 1 958 975 B1. Other two-component, polyurethane-, epoxy-, or acrylate-based adhesives that cure as thermosets can also be used in principle. The adhesive is referred to as liquid in the intended state in which it is applied when it has a viscosity of <10 000 mPas, preferably <300 mPas, ideally <100 mPas (measured in the mixing head of the applicator at 35° C.-65° C., preferably 50° C. and a pressure of 70-140 bar, preferably 100 bar). This mixture viscosity can be further optimized by selecting the temperature of the components.

The curing refers in this context to the chemical solidification of the adhesive by polymerization, polycondensation and polyaddition.

The method is performed in a combined working step, in that a one- or multi-part casting mold is placed onto the substrate, filled with liquid adhesive through an opening such that the adhesive reaches the adhesion zone on the substrate and cures there in the casting mold to form a fastening element. This dispenses with the usual fixing elements. The application device is preferably equipped with a mixing head that is suitable for processing rapidly curing adhesive systems and allows the metering of small portions of adhesive, such as for example a high-pressure counterflow injection system. Such systems are obtainable for example from Isotherm AG, Uetendorf, Switzerland. Once the casting mold, which defines the form of the later fastening element, has been positioned, a shot of adhesive is pumped from the mixing head through an opening in the casting mold. The liquid adhesive thus penetrates into the cavity of the casting mold, and wets both the casting mold and the substrate. The size of the cavity can be controlled for example by spacers on the substrate. After a few seconds, the curing to form the fastening element has taken place.

The casting mold can be released from the cast fastening element. This is achieved by the use of a releasable geometry between the casting mold and the fastening element and a non-adhering material pairing between the adhesive and the material of the casting mold. Typically, materials with low surface tension are used, for example fluorinated hydrocarbons or additional release agents.

A force transfer between the casting mold and the cast fastening element comes about as a result of the form-fitting interaction. The casting mold may be released and used for casting a further fastening element or else serve as a flexible counterpart of a snap-fastener-like connection and remain on the fastening element. Casting molds are either released in one piece as flexible molds or demolded, in that their individual parts, if they are of a multi-part form, are separately removed.

In a further embodiment, the method described above is applied by using a one- or multi-part casting mold that may have varying lengths or be adjustable in length, which is placed onto substrates with differing roughnesses of the surface, substrates with porous surfaces or a single substrate with varyingly rough or porous regions of its surface and is filled with a liquid adhesive through an opening, preferably with polyurea, so that a fastening element molded onto the substrates in the form of a rail or some other profile of variable length is obtained. It is also possible for rails or other profiles of variable length to be molded onto non-planar substrates.

After curing of the adhesive, the casting mold adhering in a form-fitting manner may be detached or demolded in one piece as a flexible mold in the manner of a snap fastener from the rail or the profile of variable length molded onto the substrates from the adhesive, in that their individual parts, if they are of a multi-part form, are separately removed.

Subsequently, prefabricated fastening elements may be connected in a form-fitting manner, in variable number and with variable spacing from one another, to the rail or the profile and also be detached again from it. Fastening elements of cable harnesses serve as an example.

Furthermore, the method described above may be applied with a one- or multi-part casting mold which is placed onto porous substrates or substrates with differing surface roughness or a single substrate with varying rough or porous regions of its surface and be filled with liquid adhesive through an opening, preferably polyurea. The casting mold is designed with threaded grooves in such a way that, after the curing of the adhesive and the removal of the casting mold or the casting molded parts, a fastening element with an external thread is obtained, i.e. for example in the form of a screw that is located on the substrate surface.

Similarly, the method described above may be carried out with a one- or multi-part casting mold which is placed onto porous substrates, substrates of differing surface roughness or a single substrate with varying rough or porous regions of its surface, which has a recess, preferably a depression, in such a way as to form a cavity that extends from the interior of the casting mold above the substrate surface into the substrate below the surface. The casting mold is filled with liquid adhesive through an opening, preferably with polyurea. After curing of the adhesive, the casting mold or the parts of the casting mold is/are removed in such a way as to leave behind on the substrate a fastening element that is anchored in a form-fitting or material-bonding and form-fitting manner in the substrate below its surface. For example, the anchoring of such a fastening element may have the form of a dovetail, the lower half of which is located in the substrate and the upper half of which is located on the substrate surface. The part of the fastening element that serves for the fastening of a counterpart above the substrate surface extends above the substrate surface and the anchoring.

In a further embodiment of the invention, a method for the in-situ production of a fastening element on porous substrates, substrates with differing surface roughness or a single substrate with varying rough or porous regions of its surface is provided, characterized in that a one- or multi-part casting mold, which has, in addition to an opening for filling with liquid adhesive, at least one further opening through which a molded part can be introduced into the cavity before or during the filling of the casting mold with liquid adhesive or before the curing of the liquid adhesive, is placed onto the substrates, a molded part is introduced into at least one of the openings, the casting mold is filled with a liquid adhesive through an opening and the adhesive cures to form a fastening element. After the curing of the adhesive, both the casting mold and the molded part are released, for example by removal or unscrewing, the casting mold by demolding its individual parts or in one piece as a flexible mold. The fastening element obtained is located on the substrate surface and comprises a depression, such as for example an internal thread, with the aid of which a counterpart, such as for example a screw, can be securely screwed thereto or securely inserted therein.

A method for the in-situ production of a fastening element, a molded part being introduced through at least one further opening into the cavity of the one- or multi-part casting mold, is also possible if the substrate onto which the casting mold is placed comprises a recess, as described above. After placing a casting mold, in particular a multi-part casting mold, onto a substrate above the recess and after, or shortly before, the introduction of a molded part into at least one opening of the casting mold, liquid adhesive is filled in through another opening in the casting mold. After the curing of the adhesive, the molded part is released, for example by removal or unscrewing, and the casting mold is demolded by removing its individual parts or in one piece as a flexible mold. Left behind is a fastening element that is anchored in the substrate underneath the surface, in particular by a form fit, and has above the substrate surface a depression, for example in the form of an internal thread, with the aid of which a counterpart can be fastened, in that it is inserted or screwed in.

The molded part that is introduced into the cavity of the casting mold through at least one further opening may be for example a screw, a bolt, a punch, a rivet or a pin.

A further method according to the invention concerns the attachment of prefabricated fastening elements on substrates by means of an adhesive, comprising the providing of one or more substrates, the arranging of a fastening element on or above the substrate surface, the introducing of adhesive through an opening in the fastening element, in particular the lowering of a fastening element onto the substrate, and the curing of the adhesive.

Prefabricated fastening elements may be brackets, angles, bolts, clips, sleeves, internal threads, screws, pins, recesses, projections, rails, barbs or rivets and may consist for example of plastics or metal.

Substrates may have differing roughnesses of the surface or a porous surface. A single substrate may also have varyingly rough or porous regions of its surface. The fastening elements of adhesive according to the invention adhere on substrate surfaces of low roughness as well as on porous surfaces or surfaces that are very rough. Moreover, substrates that are non-transparent can be used.

The adhesive is a rapidly curing polyurea-based two-component adhesive, as described in EP 1 958 975 B1. Other two-component, polyurethane-, epoxy-, or acrylate-based adhesives that cure as thermosets can also be used in principle. The adhesive is referred to as liquid in the intended state in which it is applied when it has a viscosity of <10 000 mPas, preferably <300 mPas, ideally <100 mPas (measured in the mixing head of the applicator at 35° C.-65° C., preferably 50° C. and a pressure of 70-140 bar, preferably 100 bar). This mixture viscosity can be further optimized by selecting the temperature of the components.

The curing refers in this context to the chemical solidification of the adhesive by polymerization, polycondensation and polyaddition.

The method for fastening a prefabricated fastening element on a substrate with the aid of plastic is preferably automated and carried out in one working step. For this purpose, for example, a device for attaching a fastening element is used, comprising a magazine, which contains prefabricated fastening elements, and an application device for liquid adhesive, which is designed such that the adhesive can be applied to one or more substrates through one or more openings in the fastening element. A prefabricated fastening element is brought out of the accompanying magazine of the device for attaching a fastening element to the mounting point on or above the substrate surface and held in this position. Liquid, two-component adhesive is prepared in a mixing head and applied to the substrate surface with the aid of the application device of the device for attaching a fastening element through one or more openings in the prefabricated fastening element. This application of adhesive may in this case be performed in such a way as to use such an amount of adhesive that an intermediate space space between the fastening element placed on the substrate and the substrate surface is filled. Alternatively, an amount of adhesive may also be applied to the substrate surface through one or more openings in the fastening element held above the substrate and the fastening element lowered onto the amount of adhesive, or an amount of adhesive is applied through the opening or openings in a prefabricated fastening element held above the substrate surface, the fastening element being raised as a result of the volume of adhesive. Until the curing of the adhesive, the fastening element is held in position by means of the device for attaching a fastening element, before the device moves on to the next mounting point on the substrate surface.

A further aspect of the invention concerns the use of an adhesive to be applied in liquid form for the in-situ production of a fastening element or for attaching a prefabricated fastening element on substrates.

The adhesive is a rapidly curing polyurea-based two-component adhesive, as described in EP 1 958 975 B1. Other two-component, polyurethane-, epoxy-, or acrylate-based adhesives that cure as thermosets can also be used in principle. The adhesive is referred to as liquid in the intended state in which it is applied when it has a viscosity of <10 000 mPas, preferably <300 mPas, ideally <100 mPas (measured in the mixing head of the applicator at 35° C.-65° C., preferably 50° C. and a pressure of 70-140 bar, preferably 100 bar). This mixture viscosity can be further optimized by selecting the temperature of the components.

The fastening element, produced in-situ by using an adhesive to be applied in liquid form or a prefabricated fastening element, may be a clip, a bolt, a sleeve, an internal thread, a screw, a pin, a recess, a projection, a rail, a barb, a rivet, a bracket or an angle.

The substrates on which the adhesive to be applied in liquid form is used for the in-situ production of a fastening element or for attaching a prefabricated fastening element have differing surface roughnesses, porous surfaces or, on single substrates, also varying rough or porous regions of the surface.

The use described above of the adhesive to be applied in liquid form takes place by the adhesive being filled through an opening in a one- or multi-part casting mold, which has previously been placed onto a substrate surface, into the cavity of the casting mold and left to cure there to form a fastening element.

The casting mold is releasable from the cured fastening element either by demolding multiple parts or in one piece as a flexible mold. In addition to the opening for filling with liquid adhesive, it may also comprise at least one further opening, through which a molded part that is releasable from the cured fastening element can be introduced into the cavity of the casting mold before or during the filling with liquid adhesive or before the curing of the liquid adhesive.

Alternatively, the adhesive to be applied in liquid form may also be used by the liquid adhesive being applied to the substrate through one or more openings in a prefabricated fastening element that is held above or on the substrate surface, with either an intermediate space between the substrate and the fastening element being filled with adhesive, or the fastening element being lowered onto an amount of adhesive on the substrate, or the fastening element being raised as a result of the volume of adhesive.

The use according to the invention of the adhesive to be applied in liquid form for the in-situ production of a fastening element or for attaching a prefabricated fastening element on substrates with porous surfaces, surfaces of differing roughness or varying rough or porous regions on the surface of single substrates may be performed with the aid of a device for attaching a fastening element which is equipped with an application device for liquid adhesive and a magazine that transports casting molds or prefabricated fastening elements to the mounting point on the substrate, positions them, fills them with liquid adhesive through one or more openings in the casting mold in the prefabricated fastening element and holds them until the adhesive in the casting mold or underneath the prefabricated fastening element has cured.

A further aspect of the invention is that of substrates with fastening elements that are obtainable by one of the methods described above.

The substrates may have differing roughnesses of the surface, porous surfaces or else varying rough or porous regions of the surface of a single substrate.

The fastening element may be a clip, a bolt, a sleeve, an internal thread, a screw, a pin, a recess, a projection, a rail, a barb, a rivet, a bracket or an angle.

A further aspect of the invention is a device for attaching a fastening element which is equipped with an application device for liquid adhesive and a magazine that transports casting molds or prefabricated fastening elements to the mounting point on the substrate, positions them, fills them with liquid adhesive through one or more openings in the casting mold in the prefabricated fastening element and holds them until the adhesive in the casting mold or underneath the prefabricated fastening element has cured.

### DESCRIPTION OF THE FIGURES

The invention is explained in more detail by the following exemplary embodiments in FIGS. 1a to 5, without the invention being restricted to these embodiments.

FIGS. 1a and b represent the lateral cross section of a casting mold 1, for example a rotationally symmetrical or rectangular casting mold 1, which can be released again from the substrate, has an opening for filling with an adhesive 2 and spacers 3 and is placed onto a substrate 4 and filled with liquid adhesive through the opening 2. After curing of the adhesive, the flexible casting mold 1, adhering in a form-fitting manner, can be detached as a whole in the manner of a snap fastener from the fastening element 5 molded onto the substrate from adhesive.

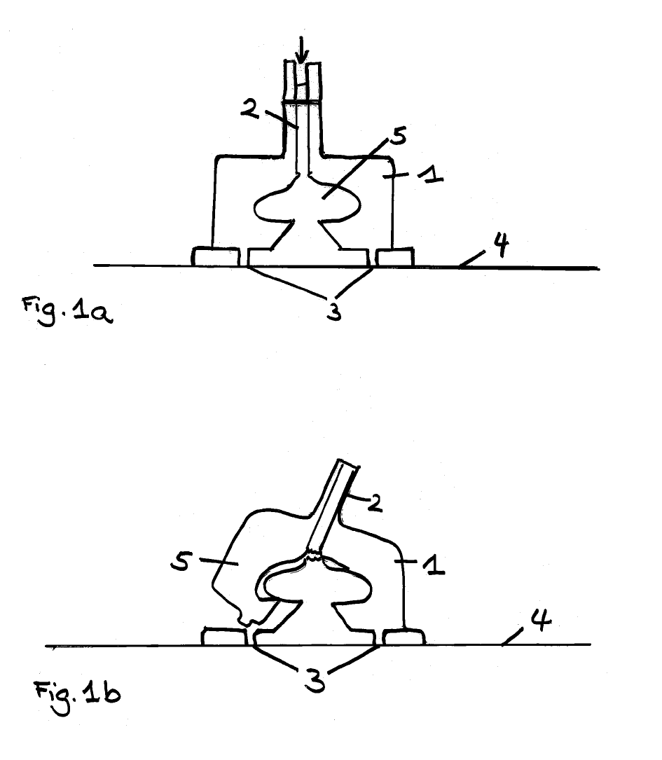

FIG. 2 shows the lateral cross section and the plan view of a modification of the fastening element that is shown in FIGS. 1a and b. A rectangular casting mold, which may have differing lengths or be adjustable in length, is placed onto a substrate 4 and filled with liquid adhesive through an opening 2. After curing of the adhesive, the casting mold, adhering in a form-fitting manner, can be detached in one piece in the manner of a snap fastener, as shown in cross section in FIG. 1b, or in individual parts from the rail 6 molded onto the substrate 4 from the adhesive. Clips 5, which correspond to the casting molds 1 used in FIGS. 1a and b, may be connected in a form-fitting manner, in variable number and with variable spacing from one another, to the rail 6 and also be detached again from it.

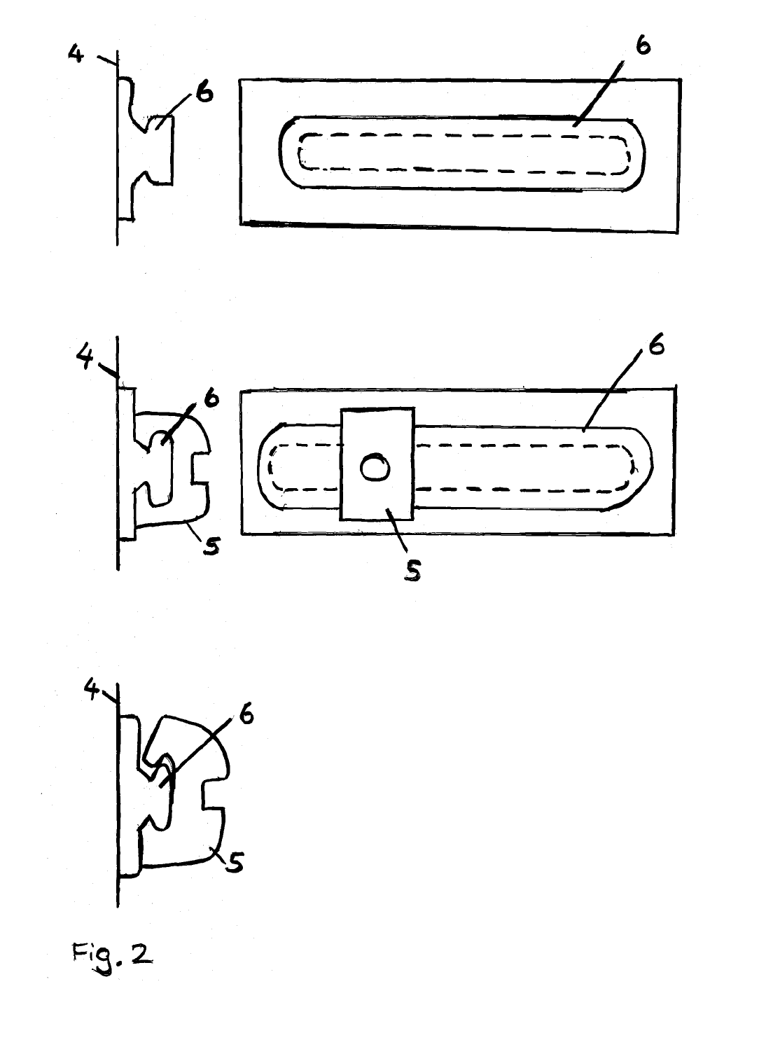

In FIG. 3, a rotationally symmetrical or rectangular casting mold 7 that is placed onto a substrate 4 and filled with liquid adhesive through an opening 2 is depicted in lateral cross section. The casting mold is designed with threaded grooves in such a way that, after the curing of the adhesive and after the removal of the casting molded parts or the casting mold in one piece, a fastening element with an external thread 8 is obtained for example.

FIG. 4 shows in lateral cross section a rectangular or rotationally symmetrical casting mold 9 with an opening 2 that is placed onto a substrate 4, which has a recess in the form of a half dovetail 10, in such a way as to produce a cavity that creates a dovetail with a punch 11, one half of the dovetail being located in the substrate, the other half being located above the substrate. The casting mold 9 is filled with liquid adhesive through the opening 2. After curing of the adhesive, the parts of the casting mold 9 or the casting mold in one piece are/is removed in such a way as to leave behind on the substrate a fastening element 12 that is anchored in the substrate and has a punch 11.

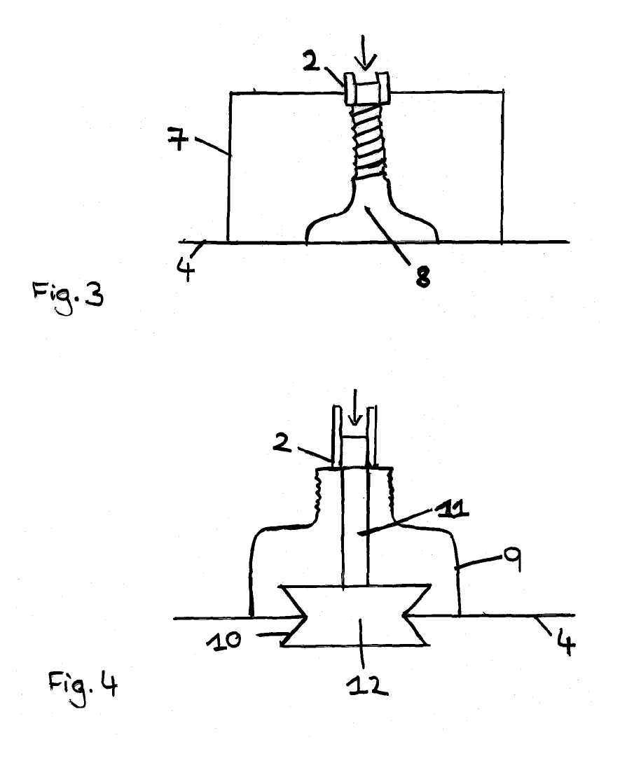

FIG. 5 represents a lateral cross section of a multi-part, for example rotationally symmetrical or rectangular, here three-part casting mold 13, which is placed onto a substrate 4 and comprises an opening 2 for filling with liquid adhesive, and also a second opening 14. Through the second opening, a molded part 15 is introduced into the cavity. Through the opening for filling with liquid adhesive 2, the casting mold is filled with liquid adhesive. After curing of the adhesive, the three parts of the casting mold are released and the molded part 15 of the cured adhesive is demolded. FIG. 5 shows a screw as molded part 15, so that, after removal of the casting mold and demolding of the molded part, a fastening element 16 that is molded onto the substrate and has an internal thread is obtained.

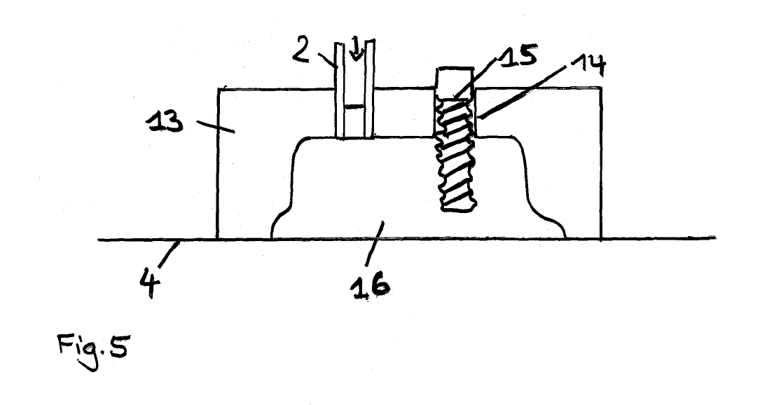

1-15. (canceled)

16. A method for the in-situ production of a fastening element, comprising
a) providing of one or more substrates,
b) arranging a one- or multi-part casting mold on the substrate or the substrates,
c) filling the casting mold with a liquid adhesive through an opening, and
d) curing the adhesive on the substrate or the substrates.

17. The method as claimed in claim 16, wherein the substrates have a recess in the surface, into which the adhesive penetrates.

18. The method as claimed in claim 16, wherein a molded part is introduced into the cavity of the casting mold before the filling of the casting mold with adhesive.

19. The method as claimed in claim 18, wherein the molded part is released after the curing of the adhesive.

20. The method as claimed in claim 19, wherein the molded part is a screw, a bolt, a punch, a rivet or a pin.

21. The method as claimed in claim 16, wherein the casting mold is released from the fastening element in a further method step e).

22. A method for attaching a fastening element on a substrate, comprising
a) providing of one or more substrates,
b) arranging of a fastening element on or above the substrate surface,
c) introducing of adhesive through an opening in the fastening element into the intermediate space between the substrate surface and the underside of the fastening element,
d) in particular lowering of the fastening element onto the substrate, and
e) curing of the adhesive.

23. The method as claimed in claim 22, wherein the adhesive is a polyurea-based adhesive.

24. The method as claimed in claim 22, the fastening element being a clip, a bolt, a sleeve, an internal thread, a screw, a pin, a recess, a projection, a rail, a barb, a rivet, a bracket or an angle.

25. The method as claimed in claim 22, wherein in method step a) the substrates comprise surfaces of differing roughness or a substrate comprising regions of differing roughness.

26. The use of an adhesive to be applied in liquid form for the in-situ production of a fastening element on a substrate.

27. The use as claimed in claim 26, wherein the adhesive is a polyurea-based adhesive.

28. The use as claimed in claim 26, wherein the fastening element is a clip, a bolt, a sleeve, an internal thread, a screw, a pin, a recess, a projection, a rail, a barb, a rivet, a bracket or an angle.

29. A substrate with a fastening element, obtainable by the method as claimed in claim 16.

30. A device for attaching a fastening element comprising a magazine containing fastening elements or casting molds and an application device for liquid adhesive, the application device being designed such that the adhesive can be applied through one or more openings in the fastening element or through one or more openings in the casting mold.
